(19) United States
(12) Patent Application Publication
(10) Pub. No.: US 2006/0083834 A1
(43) Pub. Date: Apr. 20, 2006

(54) Process for granulation of wet processed foods and use thereof

(75) Inventors: Manoj Shah, Lindenhurst, IL (US); Maria Elena Almendarez, Chicago, IL (US); Frank Cole, Glenview, IL (US); Sarwat Gabriel, Grayslake, IL (US); David Makowski, Deer Park, IL (US); Douglas M. Lehmann, Park Ridge, NJ (US); Kenchu A. Tham, Sparta, NJ (US); Allan R. Olson, Kalamazoo, MI (US); Philip F. Litsas, Battle Creek, MI (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc., Northfield, IL (US)

(21) Appl. No.: 10/963,746

(22) Filed: Oct. 14, 2004

(51) Int. Cl. A23P 1/00

(52) U.S. Cl. 426/518

(57) ABSTRACT

A single-stage process for drying and grinding of wet processed food material in a single unit operation in a continuous short duration manner. The granulated food product obtained from the single-stage treatment of wet processed food is suitable for re-use in food production lines.

### FIELD OF THE INVENTION

The invention generally relates to a process for single-stage drying and grinding of wet processed food and incorporation of the ground foods in food products.

### BACKGROUND OF THE INVENTION

In the production of many types of food products, some unused wet processed food portions are sometimes left as trimmings, shreds, offcuts, fragments, and so forth, after a batch run or other production run. Also, small quantities of processed food product that may not conform to a desired shape or configuration also may be rejected and not used in a commercial product. Ideally, such small quantities are combined with larger quantities for use as rework in subsequent food production. This often requires heating, mechanical grinding, milling or other processing steps to reform the wet processed food into a more convenient or stable form, which can lead to difficulties.

Heating wet farinaceous foods to dehydrate them, for instance, may be problematic as the material can be subject to gelatinization or other significant physico-chemical transformations upon heat treatment and/or exposure to heat associated with conventional grinding or milling operations. For commercial reasons, control of gelatinization of farinaceous material in some food systems is important as it may have a direct impact on final product quality, particularly product texture. In addition, the degree of gelatinization of farinaceous material in food systems also may impact the processing rheology of a starch melt/dough or similar foodstuff. This may affect the expansion and bubble growth kinetics of the food product. A farinaceous food material may not be economically and/or functionally useful in further processed food production if the original starch content becomes unduly degraded.

Another challenge to reforming wet processed food materials is that they may have a tacky surface texture. For instance, moistened food materials containing, for example, starches, sugars, and/or gums, may be prone to adhere to contacted surfaces of process equipment. Also, significant water content left in rework may need be accounted for when it is re-introduced into certain food formulations, such as some doughs, which may be sensitive to overall water content levels.

Arrangements are needed for reforming wet processed foods at a high recovery rate in a shelf-stable, food grade, functional form for re-use, which entails fewer process steps and equipment requirements. The present invention addresses the above and other needs in an efficient and economically feasible manner.

### SUMMARY OF THE INVENTION

This invention provides a process for drying and grinding wet processed foods in a single unit operation into re-usable food grade, functional particulate forms. This process combines and executes these different thermal and physical treatments in a short duration single-stage operation that substantially preserves desirable functional aspects of the processed foods which are useful for food manufacture. In one aspect, a food product is obtained from this process incurs sufficiently limited molecular structural degradation during this process such that the product of this process is functionally and organoleptically acceptable to be used as rework. In one particular aspect, the structural degradation of starch content of a processed food is avoided or minimized by this process. For purposes herein, a “processed food” refers to a food material which has already undergone a physical or chemical change as part of a previous food treatment, such as a thermal treatment, causing the character thereof to be different from the original food material. Such processed foods tend to be more sensitive to further thermal treatment in particular, and thus generally may be less apt to tolerate it without undergoing significant structural degradation.

In some embodiments, the types of wet processed foods that may be dehydrated and ground via single-stage treatment may be wet processed foods which contain a grain-based ingredient, for example, wet dough. Such wet dough may include, for example, bread dough, pizza dough, cereal dough, pet food dough, cracker dough, baked good dough, and the like.

In one particular embodiment, the grain-based ingredient comprises farinaceous material, and granular food products containing the farinaceous material emerge from the single-stage drying and grinding treatment substantially functionally intact and substantially without loss of flavor. That is, sufficient original starch structure in particular in these processed foods is retained intact and preserved through the treatment to yield a food product having functional and organoleptic attributes acceptable for reuse in rework. In this embodiment, the single-stage treatment effectively grinds wet processed foods containing farinaceous material without inducing significant or uncontrolled starch gelatinization. In another embodiment, the procesed food is a high moisture content precursor material used in pet food production, such as tankage. In yet another embodiment, the high moisture processed food may comprise moist coffee chaff by product obtained from coffee production.

In some embodiments of this invention, the single-stage treatment of wet processed food is conducted as a combined heat treatment and grinding process in which compressed heated air and wet processed food are separately introduced into an enclosure that includes a truncated conical shaped section. After introduction, the compressed heated air travels along a downward path through the enclosure until it reaches a lower end thereof. The air flows back up from the lower end of the enclosure in a central region thereof until exiting the enclosure via an exhaust duct. The wet processed food is separately introduced into an upper end of the enclosure, and the food becomes entrained in the heated air traveling downward through the enclosure until reaching the lower end of the enclosure.

During this movement of the processed food from the upper end of the enclosure down to the lower end thereof, the food is thermally and physically processed in beneficial ways. The food is dehydrated by the heated air in which it is suspended in such a dynamic air flow system. During the same unit operation, the food is disintegrated into small particles in an extremely short duration of time. After introducing the processed food into the process unit, the processed food is processed and discharged from the process unit in a short duration of time, which can be less than about 60 seconds, particularly less than about 30 seconds, and more particularly less than about 10 seconds. Significant amounts of the introduced wet processed food can be dried and ground before reaching a lower end of the enclosure. No moving mechanical parts are needed for effecting grinding of the wet processed food.

Consequently, in these embodiments, a solid particulate product including dried and ground food material is discharged and recovered from the lower end of the enclosure, while air and moisture vapor released from the food from drying is exhausted from the system via the exhaust duct. In one particular embodiment, the enclosure is a two-part structure including an upper cylindrical shaped enclosure in which the compressed heated air and wet processed food are separately introduced, and the cylindrical enclosure adjoins and fluidly communicates with a lower enclosure having the truncated conical shape that includes the lower end of the overall structure from which the processed feed material is dispensed.

The single-stage process for drying and grinding of wet processed food in a continuous manner in a single unit operation according to embodiments of this invention offers numerous advantages over conventional schemes for disposal of wet processed food. For one, costs associated with transporting and disposing of a food stream are reduced or eliminated. The single-stage treatment makes it possible to produce a granular food product from wet processed food at a relatively low temperature in a short duration of time. Drying and grinding processes are both achieved in a single-stage operation without impairing the desirable attributes of the food material, and without requiring different processes be performed in different equipment. Additionally, the process can be operated in a continuous mode as the compressed heated air is continuously exhausted from the system after entraining the food downward through the enclosure to its lower end, and ground food product material can be withdrawn from the lower end of the enclosure. Relatively little if any food residue is left on the inner walls of the processing unit, making it easy to clean and facilitating switching to a different type of processed food for processing within the unit. These advantages reduce process complexity, production time, and production and service costs.

### BRIEF DESCRIPTION OF THE DRAWINGS

Other features and advantages of the invention will become apparent from the following detailed description of preferred embodiments of the invention with reference to the drawings, in which:

FIG. 1 is a flow chart of a method for processing and re-using wet processed food according to an embodiment of this invention.

FIG. 2 is a schematic view of a system useful for processing wet processed food according to an embodiment of this invention.

FIG. 3 is a cross sectional view of the cyclone unit used in the processing system illustrated in FIG. 2.

FIG. 4A is a microphotograph (300×) of a sample of dried and granulated pizza dough product obtained via processing of wet pizza dough according to an embodiment of this invention.

FIG. 4B is a microphotograph (300×) of the sample of dried and granulated pizza dough product obtained via processing of wet pizza dough as viewed with polarized light.

FIGS. 5-7 are farinograph charts obtained on samples of control dough (FIG. 5), and doughs containing 5% (FIG. 6) and 10% (FIG. 7) rework comprised of dried and granulated pizza dough product obtained via processing of wet pizza dough according to an embodiment of this invention, respectively.

FIG. 8 is a bar graph showing the first taste selections of test animals of pet food biscuits including cereal-based dough rework obtained according to an embodiment of this invention as compared to the results for a control pet food on a day-by-day basis.

FIG. 9 is a bar graph showing the caloric intake by the test animals of the pet food biscuits including the cereal-based dough rework obtained according to an embodiment of this invention as compared to the results for the control pet food on a day-by-day basis.

FIGS. 10-11 are bar graphs showing the caloric intake by test animals of pet food biscuits including tankage rework obtained according to an embodiment of this invention as compared to the results for a control pet food on a day-by-day basis and overall values, respectively.

The features depicted in the figures are not necessarily drawn to scale. Similarly numbered elements in different figures represent similar components unless indicated otherwise.

### DETAILED DESCRIPTION OF THE PREFERRED EMBODIMENTS

Preferred embodiments of the invention will be described below with specific reference to unique single-stage processing of wet processed foods. For purposes herein, the term “wet” as used to characterize a food material means food material containing at least 14 wt. % total water content, in liquid, frozen and/or vapor form.

Generally, wet processed food is subjected to drying and grinding into a small particle size within a short period of time in a single-stage process performed in one unit operation. In general, the single-stage process is implemented on a cyclonic type system that may be operated in a manner whereby the wet processed food may be thermally and physically acted upon at the same time within the same processing unit in a beneficial manner. A dried and ground food product is obtained in granulated form (e.g., a solid fine particulate). The granulated form of rework obtained generally is more stable for storage and handling before reuse, e.g., re-introduction into food production.

For purposes herein, “drying” means dehydrating, i.e., reducing moisture content; and “grinding” a particle means crushing, pulverizing, abrading, wearing, or rubbing the particle to break it down into smaller particles and/or liberate smaller particles, and includes mechanisms involving contact between moving particles, and/or between a moving particle and a static surface.

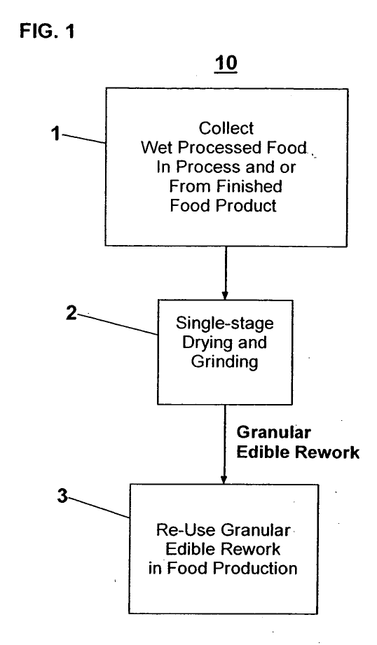

Referring to FIG. 1, in this illustrated embodiment wet processed food is collected in process or from finished food product (step 1), then is subjected to a single-stage drying and grinding treatment (step 2), and the resulting granular food product thereof or “rework” is made available for re-use as a food ingredient (step 3).

In step 2, a granular food product obtained which is suitable for use in comestibles. For instance, the granulated food product obtained substantially retains its flavor and functional attributes through the single-stage treatment. The granular food product may be stably stored until re-used in subsequent food production. The granulated food product may be used as a food ingredient in the same type of processed food production line from which it was collected, or in a different type of processed food production line in which its flavor or functional attributes may be desirable or useful. It also may be re-used at relatively high levels in further food production lines.

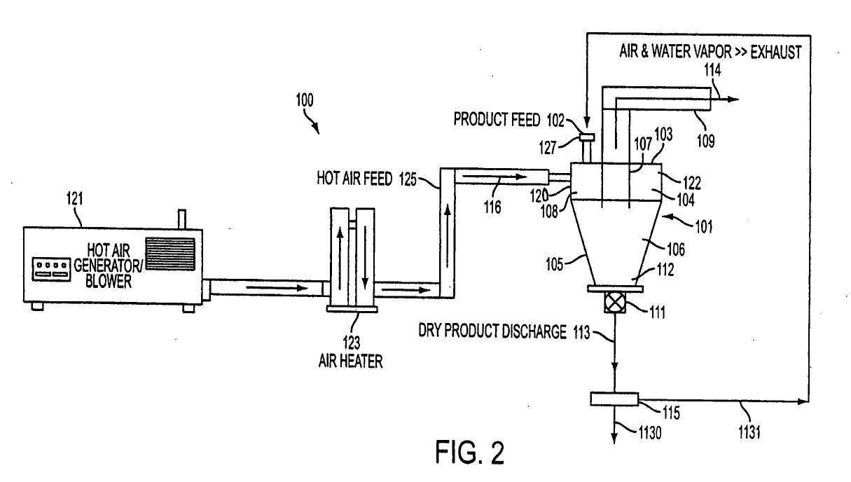

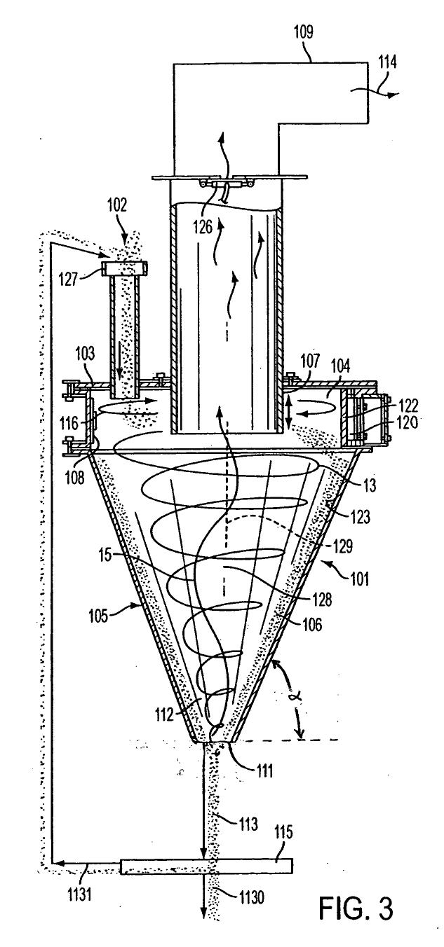

Referring now to FIGS. 2 and 3, details of an exemplary equipment arrangement and process of operating it for conducting the single-stage drying and grinding of the wet processed food in step 2 of FIG. 1 is discussed hereinafter. The wet processed food that is introduced into the cyclonic system for treatment in the process of this invention may be derived from commercial food manufacture or other sources of wet processed food materials. The wet processed food may be in the form of discrete whole pieces as originally manufactured, or as portions, parts, fragments, shreds, fragments, and so forth thereof.

Referring to FIG. 2, an exemplary system 100 for performing single-stage drying and grinding of wet processed food according to a process embodiment of this invention is shown. Cyclone 101 is a structural enclosure comprised of two fluidly communicating sections: an upper cylindrical enclosure 103 defining a chamber 104; and a lower truncated conical shaped enclosure 105 that defines a cavity 106. Both the upper and lower enclosures are annular structures in which a solid wall or shell encloses an interior space. In this illustration, the upper enclosure 103 has a generally uniform cross-sectional diameter, while the lower enclosure 105 tapers inward towards its lower end 112. In a non-limiting embodiment, the taper angle α of lower enclosure 105 may range from about 66 to about 70 degrees. For purposes herein, the terminology “enclosure” means a structure that encloses a chamber, cavity, or space from more than one side.

Compressed heated air 116 and wet processed food 102 are separately introduced into the cyclone 101 at the upper enclosure 103. The processed wet processed food is discharged as a solid particulate 113 from the lower end 112 of the cyclone 101. A valve mechanism 111, such as a rotary valve or rotary air-lock, is shown that permits extraction of dried, ground food from the cyclone without interrupting continuous operation of the system and which minimizes leakage of the heated air from the cyclone 101. If the cyclone 101 is operated without an air-lock or the like at the bottom discharge end of the cyclone 101, the system generally will run less efficiently as heated air will be forced out of the lower end 112, which will need to be compensated for in the air feed rate. Air, and moisture vapor released from the food during heat treatment within the cyclone 101, is exhausted as exhaust gases 114 from the cyclone via sleeve 107 and exhaust duct 109. Some nominal amount of light debris may be liberated from the food during processing in the cyclone, and may be eliminated with the exhaust gas stream 114. The exhaust gas stream 114 optionally may be particle filtered, and/or scrubbed to strip out sulfur-containing compounds or other compounds, such as using a separate scrubber module (not shown), e.g. a packed bed type scrubber, before it is vented to the atmosphere. Sieving device 115 is optional, and is described in more detail later herein. Generally, it can be used to separate oversize or coarser product in particulate product 113 which may be re-introduced into the cyclone 101 for additional treatment by itself or in combination with fresh food feedstock that has not yet been treated therein.

To introduce the compressed heated air 116 into cyclone 101, an air pressurizing mechanism 121, such as a blower or air compressor, generates a high volume, high velocity compressed air stream that is conducted via hot air ducting 125 through an air heater 123, and from there is introduced into upper enclosure 103 of cyclone 101. For purposes herein, the term “heated air” refers to air heated to a temperature above ambient temperature, e.g., above 75° F. (24° C.). The term “compressed air” refers to air compressed to a pressure above atmospheric pressure, e.g., above 14.7 psia (lb./inch² absolute). The term “compressed heat air” refers to air having both these characteristics. The compressed heated air 116 is introduced into chamber 104 substantially tangentially to an inner wall 108 of the upper enclosure 103. This can be done, for example, by directing the heated air stream 116 to a plurality of holes 120 (e.g., 2 to 8 holes) circumferentially spaced around and provided through the wall 108 of the upper enclosure 103 through which the heated air stream is introduced. Deflection plates 122 can be mounted on inner wall 108 of upper enclosure 103 for deflecting the incoming stream of heated air into a direction substantially tangential to the inner wall 108 according to an arrangement that has been described, for example, in U.S. patent application publication no. 2002/0027173 A1, which descriptions are incorporated herein by reference. The heated air may be introduced into the upper enclosure 103 of cyclone 101 in a counter-clockwise or a clockwise direction.

The introduced air 10 generally may be further pressurized cyclonically in the chamber 104 and cavity 106. Due to the centrifugal forces present in the cyclonic environment, it is thought that the pressure nearer the outer extremities of the cavity 106 is substantially greater than atmospheric pressure, while the pressure nearer the central axis of the cavity 106 is less than atmospheric pressure. As shown in FIG. 3 as a non-limiting illustration, after being introduced into upper enclosure 103, the compressed heated air 116 spirals along a large downward path as a vortex 13 through the upper enclosure 103 and the lower conical shaped enclosure 105 until it reaches a lower end 112 thereof. In this illustration, near the lower end 112 of the cavity 106 defined by the inner walls 123 of lower enclosure 105, the downward direction of the air movement is reversed, and the air (and moisture vapor released from the food during heat treatment within the cyclone 101) whirls back upwardly as a smaller vortex 15 generally inside the larger vortex 13. The smaller vortex 15 flows back up from the lower end 112 of the lower enclosure 105 in a central region 128 located proximately near the central axis 129 of the cyclone 101 and generally inside the larger vortex 13. The smaller vortex 15 flows upward until exiting the enclosure via sleeve 107 and then exhaust duct 109.

A vortex breaking means (not shown) optionally can be interposed below or inside the lower end 112 to encourage the transition of the larger vortex 13 to the smaller vortex 15. Various vortex breaking arrangements for cyclones are known, such as the introduction of a box-shaped enclosure at the bottom of the conical enclosure.

The wet processed food 102 is separately introduced into upper enclosure 103. The introduced wet processed food drops gravitationally downward into chamber 104 until they become entrained in the heated air vortex 13 within cyclone 101. Preferably, the wet processed food is introduced into upper enclosure 103 in an orientation such that they will fall into the cyclonic vortex 13 generated within cyclone 101, where located in the space between the sleeve 107, and inner wall 108 of the upper enclosure 103. This feed technique serves to minimize the amount of wet processed food that may initially fall into extreme inner or outer radial portions of the vortex where the cyclonic forces that the food experiences may be lower.

The entrained food travels in the vortex 13 of heated air spirals or otherwise travels generally downward through the lower enclosure 105 until reaching the lower end 112 of the lower enclosure 105. During this downward flow path, the food is dehydrated by the heated air in which they are suspended in such a dynamic air-flow system. They also are ground during the downward flow path. The various dehydration and grinding effects on the food may occur at different respective times, and/or several of the effects may occur simultaneously at a particular point or points in time, during the downward flow path of the food through the cyclone. While not desiring to be bound to any theory, it is thought that possible pressure-gradient and coriolis forces across, cavitation explosions, and the collision interaction between the food particles entrained in the high-velocity cyclonically pressurized air may be violently disruptive to the physical structure of that processed material. Alternatively, or in addition thereto, the centrifugal force of the vortex may move the processed material forcefully against inner walls 108 and 123 of the enclosure. These modes of attrition, individually or in combination, or other modes of attrition that may occur within the cyclone which may not be fully understood, bring about comminuting (grinding) of the food concurrent with drying it. As a result, during this movement of the food from the upper enclosure 103 down to the lower end 112 of the lower enclosure 105, the processed food is thermally and physically processed in beneficial ways. The unit 101 requires no moving mechanical parts for effecting grinding of the wet processed food.

In a further embodiment of the invention, the discharged solid particulate product 113 can be screened, such as using a sieve, such as a screen sieve or other suitable particulate separation/classifying mechanism 115, to sort and separate the finer fraction of ground food 1130 in the solid particulate product 113 that have particle sizes meeting a size criterion, such as being less than a predetermined size, which are suitable for post-grinding processing, from the coarser product fraction 1131. The coarser (oversize) product fraction 1131 can be redirected it into the upper enclosure of the cyclone for additional processing therein. A conveyor (not shown) could be used to mechanically transport the coarser material back to feed introducing means 127 or other introduction means in upper enclosure 103 of cyclone 101. Also, a feed introducing means (not shown), such as an inclined conveyor, may be used to transport feed material from a lower location up to and into chamber 104 of the cyclone 101 at the upper enclosure 103. It will be appreciated that sleeve 107 can be controllably moved up and down to different vertical positions within cyclone 101. In general, the lower sleeve 107 is spaced relative to the cavity 106, the smaller the combined total volume of the cyclone 101 which is available for air circulation. Since the volume of air being introduced remains constant, this reduction in volume causes a faster flow of air, causing greater cyclonic effect throughout cavity 106 and consequently causing the food to be ground to circulate longer in the chamber 104 and the cavity 106. Raising the sleeve 107 generally has the opposite effect. For a given feed and operating conditions, the vertical position of sleeve 107 can be adjusted to improve process efficiency and yield.

Also, a damper 126 can be provided on exhaust duct 109 to control the volume of air permitted to escape from the central, low-pressure region of cavity 106 into the ambient atmosphere, which can affect the cyclonic velocities and force gradients within cyclone 101.

By continually feeding processed food into cyclone 101, a continuous throughput of dried and ground food product material 113 is obtained. A non-limiting example of a commercial apparatus that can be operated in a continuous manner while processing food according to processes of this invention is a WINDHEXE apparatus, manufactured by Vortex Dehydration Systems, LLC, Hanover Md., U.S.A. Descriptions of that type of apparatus are set forth in U.S. patent application publication no. 2002/0027173 A1, which descriptions are incorporated in their entirety herein by reference.

The cyclonic system 100 provides very high heat transfer rates from hot air to processed food for drying, and mechanical energy to crack and granulate food as it descends through the conical section of the dryer. The food exiting the cyclone 101 exhibits a flowable solid particulate type form, which may be a flour or powder like material. The one-stage process offers numerous advantages over conventional schemes for handling wet processed food, while eliminating the need for separate drying and grinding processes and equipment.

In one process scheme for processing wet processed food, the introduction of the heated air comprises supplying compressed heated air at an inlet pressure within the range of from about 10 psig (lb./inch² gauge) to about 100 psig, particularly from about 30 psig to about 60 psig, and more particularly from about 42 psig to about 52 psig. The heated air generally is introduced into the cyclone at a temperature within the range of about 120° F. to about 900° F., particularly about 120° F. to about 375° F., more particularly about 120° F. to about 350° F., and even more particularly about 240° F. to about 350° F. In one aspect, the air temperature does not exceed about 250° F. At air temperatures below about 120° F., particularly at high ambient relative humidity conditions, the wet processed food may tend to cake or form pastes inside the cyclone unless the compressed air is also dehumidified before it is introduced into the cyclone. As the air temperature is increased, the air generally has more water holding capacity and wet procesed food caking or pastiness is more easily avoided. If the air temperature is too high, the processed food may become heat damaged. The volumetric introduction rate of the heated air into the cyclone is within the range of from about 500 cubic feet per minute (CFM) to about 10,000 CFM, particularly from about 800 CFM to about 10,000 CFM, and more particularly from about 1,000 CFM to about 3,000 CFM. The feed rate of the wet processed food can vary, but generally may be in the range of about 1 to about 300 pounds per minute, particularly about 50 to about 150 lbs./min, for about a 1 to about a 10 foot diameter (maximum) cyclone. The cyclone diameter may be, for example, from about 1 to about 10 feet in diameter, and particularly about 1 to about 6 feet in diameter.

The wet processed food may be processed within the above-noted cyclone arrangement within a very short period of time. In one embodiment, upon introducing the wet processed food into the cyclone, a dried and granulated product thereof is discharged from the processing unit within about 15 seconds, and particularly within about 1 to about 5 seconds.

Substantially all the introduced wet processed food may be discharged as processed product within such a short period of time. The above-noted processing temperatures and durations applied during drying and grinding of the wet processed food generally are low enough to help prevent any significant undesired changes in the starch structure, or other physico-chemical attributes relevant to food-processing, from occurring during the single-stage drying and grinding treatment such as described herein. The starch content is preserved substantially intact through the drying and grinding of the wet processed food.

In one embodiment, the wet processed food used as the feed material of a single-stage drying and grinding process generally contain at least about 14 wt. % moisture, particularly about 14 wt. % to about 99 wt. % moisture, and more particularly about 14 wt % to about 75 wt % moisture, when introduced into the cyclone 101 of system 100. The dried and ground (granulated) food product obtained from the process generally contains about 1 wt. % to about 13 wt. % moisture, particularly about 6 wt. % to about 13 wt. % moisture.

Ground food product obtained by a single-stage drying and grinding process preferably has commercially useful particle sizes. In one embodiment, the dried, ground food product obtained by processing wet processed food according to an embodiment of this invention generally may have an average particle size of about 1 micron to about 1,000 microns, particularly about 2 to about 1,000 microns. In one embodiment, the solid particulate product obtained as the bottoms of the cyclone comprise at least about 50% ground food product having an average particle size of about 1 micron to about 1,000 microns.

The granular food product obtained in accordance with embodiments of this invention is edible and may be used in a wide variety of foodstuffs for a variety of purposes. For example, it may be used as a functional ingredient, a flavoring ingredient, or a filler, or combinations thereof. The granulated food product preferably does not have an unpleasant taste or odor, and may be easily processed with doughs, processed meats, and other processed foods without loss of quality. For example, the granulated food product of embodiments of this invention serves as an economical replacement for original ingredients used in such food products. The granulated food product has ability to contribute flavor and function without adversely impacting such food products. The granulated food product obtained generally is shelf stable, and may be used to impart flavor and/or functional properties to a food product being manufactured after many months of storage of the granulated food product, such as up to about twelve months storage/shelf life or more.

In some preferred embodiments, the wet processed foods according to an embodiment of this invention contain a grain-based ingredient. The grain-based ingredient may include one or more principal parts of cereal grain, such as the pericarp or bran (external layer of grain), the endosperm (farinaceous albumen containing starch), or the germ (seed embryo). Examples are cereal grains, meals, flours, starches, or glutens, obtained from grinding cereal grains, such as wheat, corn, oats, barley, rice, rye, sorghum, milo, rape seed, legumes, soy beans, and mixtures thereof, as well as brans thereof. In one embodiment, the wet processed food generally may contain, on a dry basis, about 1 to about 99 wt. %, and particularly about 5 to about 95 wt % grain-based ingredient, and the remainder may be comprised of one or more of meat(s), non-grain based agricultural food materials, and/or food additives.

In one embodiment, the grain-based ingredient comprises a farinaceous material, and particularly a farinaceous material obtained or derived from cereal grain(s). Farinaceous materials include the above-noted cereal grains, meals or flours, as well as tuberous foodstuffs, such as potatoes, tapioca, or the like and flours thereof, and also onions, garlic, and the like. These starch-containing materials can be processed according to this invention without incurring undue gelatinization or other undesirable changes. That is, starch content of the processed food is retained substantially intact through granulation processing according to embodiments herein from a structural and functional standpoint. The single stage drying and grinding unit described herein permits relatively short duration, low temperature processing to be used, which is thought to help inhibit and avoid starch transformations during processing.

The wet processed foods containing a grain-based ingredient may be selected, for example, from wet doughs. Such wet doughs may be, for example, bread doughs, pizza doughs, cereal doughs, pet food doughs, cracker doughs, baked good doughs, and so forth. In one embodiment, for example, wet sheetable dough collected from a processed food production line may be dried and ground in a single-stage procedure in accordance with an embodiment of this invention to yield a re-usable food grade granular product. For example, the granular product substantially retains a starch structure suitable for dough making. It provides a stable functional substitute for fresh dough ingredients such as flour. “Sheetable dough” is a dough capable of being placed on a generally smooth surface and rolled to a desired final thickness without tearing or forming holes. Wet sheetable doughs that may be processed according to this invention include, for example, wet pizza doughs, wet cracker doughs, wet snack chip doughs, and the like.

The wet dough may be frozen dough or moist dough. The frozen dough contains at least about 14% frozen water. The moist dough contains at least about 14 wt. % liquid water. This moist dough generally may include dough at room temperature and which may be warmed or cooled somewhat, but the liquid content thereof is essentially unfrozen. The moist dough containing liquid water may be tacky, yet still may be processed according to this invention without leaving significant residues on the interior surfaces of the single-stage drying and grinding unit. Thus, the single-stage processing unit is left relatively clean and tidy, even though a tacky feed material may be involved. This can facilitate any desired change-over for processing a different type of feed material within the same unit. For instance, the type of wet processed food run through the system may be changed without the need to clean the system interior of residues of a prior treatment conducted therein on a different type of processed food.

Pizza dough recipes in which the granular product obtained from processing wet dough according to this invention may be re-used are not particularly limited. The pizza dough generally may include ingredients commonly used in recipes for pizza crust dough. These dough recipes may comprise bread flour, water, yeast, salt, and oil or shortening, and optional other ingredients such as gluten, alpha amylase enzyme, dough relaxers, mold inhibitors, egg ingredients, sweeteners, flavoring agents and so forth, in useful proportions. In one embodiment, the water content of the pizza dough may comprise about 40 to about 60 wt. %. The pizza dough recipe may include those described in expired U.S. Pat. No. 4,303,677, and commonly assigned published U.S. Pat. Appln. No. U.S. 2002/0197360 A1, which descriptions are incorporated herein by reference. Pizza doughs may be prepared from such recipes in a usual manner. The process of the invention also may be applied to treat wet doughs used in making loaved bread, or wet doughs used in making baked goods such as cookie doughs.

The granulated product obtained from wet dough in this manner may be used as a replacement for dough ingredients at substantially unrestricted levels in lieu of “fresh” solid dough ingredients such as flour. The granulated product obtained from wet dough may be used at levels of 0.1 wt % or more, and more particularly about 1 to about 99 wt %, in place of fresh flour in a dough batch.

In another embodiment, wet breakfast cereal products containing a grain-based ingredient may be dried and ground in a single-stage procedure to yield a stable granular material that can be re-used in cereal product production. One source of wet breakfast cereal products includes non-particulated extruded ropes comprising the cereal-making ingredients. Breakfast cereal products include those made as grain-based extruded products. These products generally are manufactured by feeding an at least partly ungelatinized, moist (wet) grain-based material and other cereal ingredients to an extruder having at least one rotating screw. The grain-based material is worked by rotating the screw to impart mechanical energy to mix the grain-based material and other ingredients of the breakfast cereal to form a plasticized doughy mass which is forced through at least one die orifice in a die plate to obtain an extrudate rope. Individual pieces of cereal are then formed from the extrudate rope, such as by intermittent severing of the rope using a reciprocating die.

During such a cereal production run, from the start-up and shut-down portions of the extrudate rope usually have been collected and discarded in prior practice. In the present invention these non-finished portions of cereal extrudate rope are instead fed into the single-stage drying and grinding unit, such as described herein, for reprocessing into a shelf-stable granular form suitable for re-use in subsequent cereal productions runs.

In one embodiment, the cereal feed material comprises at least about 50% (dry weight basis) cereal flours and larger sized grain components. Water may be added to moisten the dry cereal feed materials in sufficient amounts to provide cereal doughs having total moisture contents, for example, from about 25% to over 50 wt. %. The grain based feed material includes those already noted, which may comprise wheat, corn, barley, oats, rice, rye, sorghum, and mixtures thereof. If desired, the feed material may include supplemental materials to improve flavor, texture, appearance, nutrition, or other properties of the finished cereal product, including materials commonly used for these various purposes in cereals. Such supplemental materials may include, for example, one or more of sweeteners (e.g., sugars, syrups, honey), salt, minerals (e.g., calcium), vitamins (e.g., folates), flavorings (chocolate, vanilla, cinnamon, fruit flavor), fiber source (e.g., cellulose, pectin, psyllium), in suitable amounts.

Examples of the types of cereals that may have non-finished extruded rope reformed in this manner, include, for example, Post® Alpha-Bits®, Post® Honeycomb®, Post® Fruity Pebbles®, Post® Bran flakes, and Post® Shredded Wheat cereals, and the like.

In yet another embodiment, wet pet food products containing a grain-based ingredient may be dried and ground in a single-stage procedure to yield a stable granular material that can be re-used in pet food production. Dog and cat foods, for example, are generally prepared as either meal-type or canned-type rations. Such foods are generally formulated from a combination of proteinaceous and farinaceous materials. The proteinaceous material is derived from meat and/or meat sources, and/or vegetable protein sources. The farinaceous material is derived from grain products and contains starch generally but not necessarily for all cases as a major component. Wet products of these types of pet food production may be collected for re-use according to this invention.

The wet pet foods from which granular products also may be obtained and re-used includes so-called chewy dog snacks, such as those containing cereal-starch materials as textural agents or for other purposes. Examples of such chewy dog snacks include Nabisco® Milk-Bone® brand pet snacks. They also include pet snacks such as those described in U.S. Pat. Nos. 4,997,671 and 5,000, 943, which descriptions are incorporated herein by reference. Wet pet food products having a moisture content of at least about 14 wt. % may be dehydrated, ground and reformed into a granular product suitable for re-use in pet food production using the single-stage drying and grinding process of the present invention. Wet dog food processed according to an embodiment of this invention may have particles size ranging from about 2 to about 50 microns.

In another embodiment, the processed food is tankage. Tankage, also sometimes referred to as meat meal, is the rendered and dried carcass or part of a carcass of an animal. For instance, ruminant animal hides, such as those obtained from beef or pork packing operations, have been subjected to conventionally known and used extraction procedures to extract gelatin and collagen therefrom. For instance, the hides have been enzymatically hydrolyzed for solubilizing gelatin and collagen in an aqueous solution. After the gelatin and collagen extraction and separation of the solution containing the solubilized gelatin and collagen from the hide, animal skin residual remains having a high moisture content (e.g., about 60-70% moisture). For this purpose, as appreciated in the industry, swine hides may be treated with an acid protease at a pH within the acid range, while bovine hides may be treated with a base protease at a pH within the alkaline pH range. The outer layer of epithilium (i.e., the epidermis) of the resulting animal skin residual, tends to be rich in protein such as keratin. It would be desirable to convert the animal skin residual to a granulated shelf stable granular form, so that it can be more easily handled, stored, and reclaimed or used as rework. Processing according to the present invention allows for this high moisture, gelatin-extracted residual hide material to be recovered in a substantially nutritionally intact form by converting it into a stable dry granular form. The granular product obtained of the tankage in this manner is a shelf-stable source of protein and other nutrients. This granular product, for example, may be used an ingredient in pet food products.

In yet another embodiment, the high moisture processed food may comprise moist coffee chaff collected as a side product of coffee production.

The Examples that follow are intended to illustrate, and not limit, the invention. All percentages are by weight, unless indicated otherwise.

### EXAMPLES

### Example 1

Extruded ropes of Post® Honeycomb® cereal batch mix (36 wt. % moisture) were collected from the start-up and shut-down portions of a cereal production run operated on a Buhler single screw extruder. The cereal batch mixed within the extruder contained corn flour (50%), oat flour (20%), and water (30%). The cereal rope was fed into a WINDHEXE apparatus for circular vortex air-flow material grinding. The WINDHEXE apparatus was manufactured by Vortex Dehydration Systems, LLC, Hanover, Md., U.S.A. The basic configuration of that type of apparatus is described in U.S. patent application publication no. 2002/0027173 A1, and reference is made thereto. The process unit had two inlet ports equidistantly spaced around the upper portion of the apparatus through which the compressed air stream was concurrently introduced in a counter-clockwise direction.

A three-foot diameter WINDHEXE apparatus was tested. The diameter size refers to the chamber size of the enclosure into which air and wet processed food introductions were made. The conditions of this experiment are described below. The feed rate of the wet cereal rope material was set for an approximate discharge of 3 pounds solid product per minute, and approximately 20 pounds of food material was tested in the apparatus. The wet processed food was loaded into a hopper that directly fed onto a three-inch belt conveyor that fed into the WINDHEXE apparatus. Testing was performed in the three-foot diameter WINDHEXE apparatus with compressed air introduced at 250-350° F., a heated air introduction rate of 1,000 cubic feet per minute (cfm) and pressure of 40-50 psig.

A cereal product exiting the apparatus was in dried and finely ground form. This dried and granulated cereal product was discharged from the bottom of the cyclone in about two seconds after the wet processed food had been introduced into the processing unit. The granulated cereal product obtained had a particle size of −20 mesh and a moisture content of about 6%. It was shelf stable, well-retained flavor through the single-stage treatment, and it was functionally suitable for re-use as a cereal batch ingredient in a similar cereal production line to which it was originally used. It will be appreciated that it may useful in different cereal production lines. Additional studies have shown that feed rate and air temperature variation may be used to control the dry cereal product granulation and moisture content.

In separate studies performed using similar equipment and processing conditions, other wet cereal products were separately examined which included extruded ropes of batch mixes of Post® Fruity Pebbles®, Post® Bran flakes, Post® Honeycomb® Shredded Wheat, and corn grit products. The resulting dried and granulated cereal products of each run were discharged from the bottom of the cyclone in about two seconds after the respective wet cereal products had been introduced into the processing unit. They also were shelf stable powders and were functionally suitable for re-use as a cereal batch ingredient in the same or different cereal production line.

### Example 2

Extruded moist cereal pieces (e.g., >14% moisture) were studied to evaluate their capability of being reformed after being granulated in a vortex apparatus as described herein. A cereal dough was prepared in a conventional manner in a dough forming stage with the following general formulation: oat flour (65%), corn flour (10%), and water (25%). The dough was mixed in Hobart mixer and extruded using a Bonnot extruder having a die providing a shaped extrudate in rope form which was cut into small individual pieces of a size comparable, if baked, to commercial Post® Alpha-Bits® cereal pieces. The moist cereal pieces were frozen in an unbaked condition.

Testing was performed in the above-mentioned three-foot diameter WINDHEXE apparatus with compressed air introduced at 245° F., 1,000 cfm and 49 psig. About 100 pounds of the frozen Post® Alpha-Bits® cereal pieces were introduced into the cyclone described in Example 1. The process converted the low-moisture cereal pieces into a dry and powdery material having a particle size range of 2 to 50 microns, and the granulated material had a moisture content of less than 14 wt %. Granulated product was discharged from the bottom of the cyclone in about two seconds after the low-moisture cereal pieces had been introduced into the processing unit.

A batch of cereal pieces were prepared containing the ground cereal pieces as “meal rework” recovered from the above-described vortex processing, as re-work in additional cereal production. A cereal dough was prepared in a conventional manner in a dough forming stage with the following general formulation:

TABLE 1

| Dough Ingredient | Percent (wt.) |
|---|---|
| oat flour | 58 |
| rework meal | 10 |
| corn flour | 9 |
| water | 23 |

The dough was mixed in Hobart mixer and extruded using a Bonnot extruder having a die providing a shaped extrudate in rope form which was cut into small individual pieces of a size comparable, after being baked, to commercial Post® Alpha-Bits® cereal pieces. The extrudate maintained a uniform shape, held together well, and flowed easily. The dough pieces were suitable for baking into dry palatable cereal pieces.

### Example 3

Wet pizza dough was studied to evaluate its capability of being dehydrated and reformed for re-use in food production lines via the single-stage dryer and grinder unit such as described in Example 1. Frozen pizza dough trimmings (about 35 wt. % moisture) were collected from a frozen pizza production line. The pizza dough formulation used to prepare the frozen pizza dough was a mix containing white flour (58%), water (33%), soy oil (2.5%), salt (1.2%), sugar (3.5%), and dough conditioning/leavening agents (1.2%). The pizza dough was prepared and sheeted in a conventional manner, but was not baked before being frozen.

Testing was performed in the four-foot diameter WINDHEXE apparatus with compressed air introduced at 350° F., 2,500 cfm and 40-50 psig. About 20 pounds of the wet pizza dough was introduced into the cyclone described in Example 1. The process converted the wet pizza dough into a dry and powder-like material having an average particle size of about 2-50 microns and a moisture content of about 13.6%. Dried and granulated food product was discharged from the bottom of the cyclone in about two seconds after the wet dough had been introduced into the processing unit.

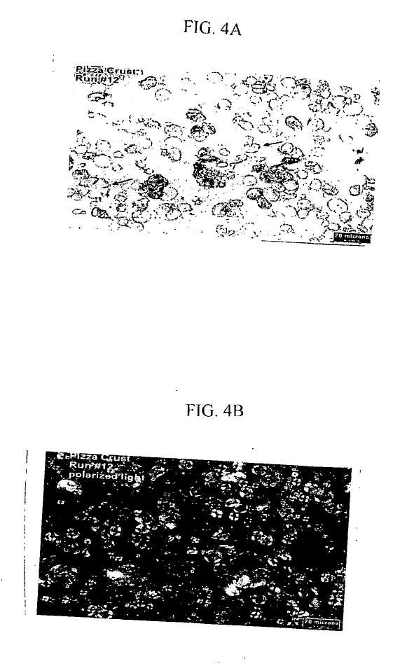

The dried and granulated pizza dough product obtained was evaluated via microscopy (300× magnification) under normal and polarized light conditions (See FIGS. 4A and 4B). Referring to FIG. 4B, in which the sample was viewed under polarize light, numerous starch molecules are seen with a crossing pattern on their surface, which is attributable to birefringence effects and is understood to indicate that the granules are not gelatinized. Therefore, the granules obtained from the pizza dough processed in the manner described above appear to be essentially intact.

The dried and granulated pizza dough product obtained was evaluated for suitability for re-use in pizza dough production lines. The pizza dough had the same basic formulation as described above as the source of the dough which was cyclonically treated except that a portion of the flour ingredient was replaced approximately 1:1 by the dried and granulated pizza dough product obtained from processing wet dough according to a process of this invention. The dough formulation described above was modified to include 5% rework in batch, and 10% rework in another batch. At these addition rates of the dried and granulated pizza dough in lieu of corresponding original flour ingredient in a new dough batch mix, the resulting dough was substantially the same as dough prepared completely with “fresh” ingredients in lieu of the dried and granulated dough material insofar as flavor and functional properties.

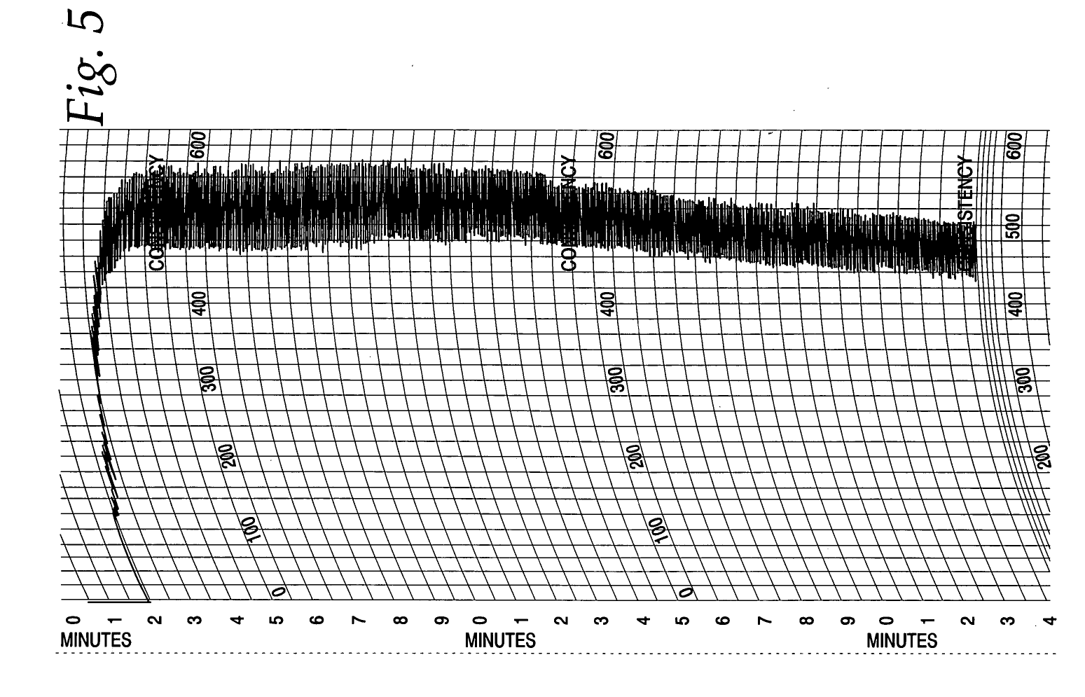

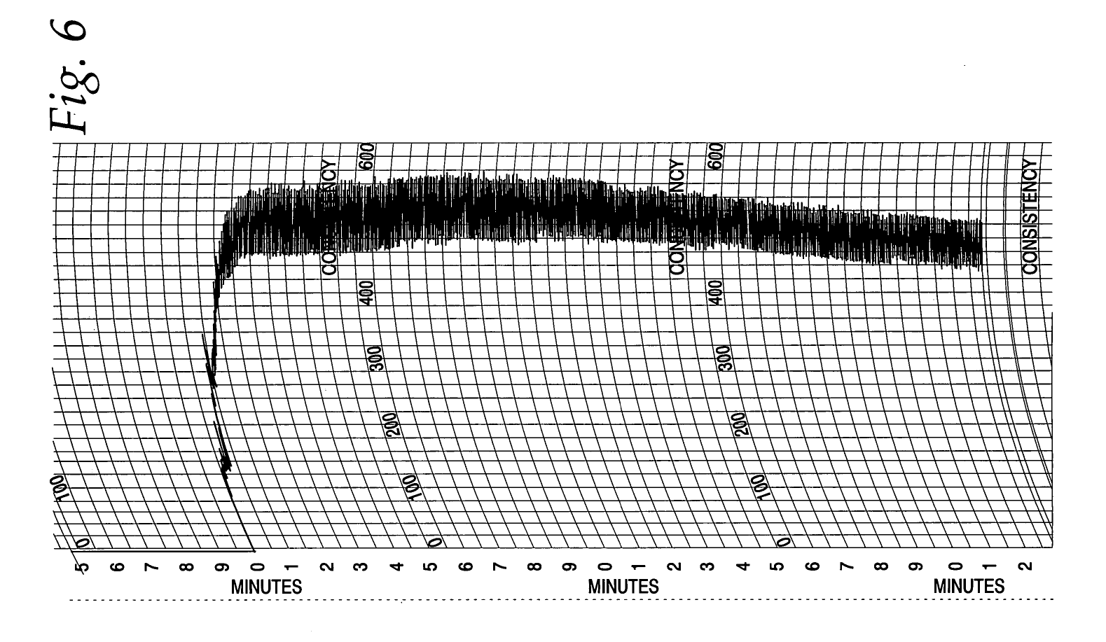

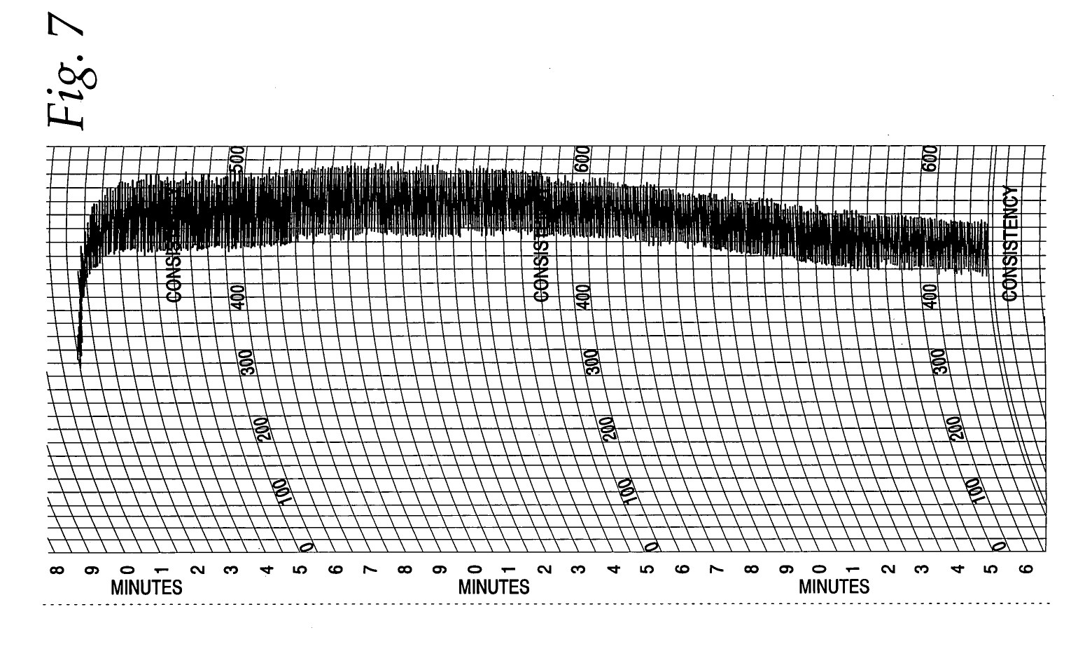

The pizza doughs were evaluated via farinographs generated using a C.W. Brabender Instrument, Inc., South Hackensack, N.J. The farino-plasto-charts generated are shown in FIGS. 5-7. FIG. 5 shows the result for a control dough, i.e., the dough without rework content, which was used as the above-described source of the wet dough which was processed in the cyclonic unit. FIGS. 6 and 7 show the results for doughs modified to contain 5% and 10% rework, respectively. As shown in FIGS. 5-7, the functional consistency attributes of the doughs containing rework were comparable to the control dough.

### Example 4

Cereal-dough based pet food biscuits were studied to evaluate their capability of being reformed after being granulated in a vortex apparatus as described herein. Pet food biscuits were prepared similar to that described for the “Control” sample illustrated in U.S. Pat. No. 5,000,943, which descriptions are incorporated herein by reference, with the following modifications. The control dough formulation prepared for this study generally contained, on a dry basis, 87% flour, 7% meat and bone meal, 2% tallow, 1% salt, 0.7% dicalcium phosphate, 0.9% natural flavorants, 0.15% vitamin premix, 0.15% calcium carbonate, and 0.4% dough conditioners. About 20-30% water was added in the preparation of the dough, based on the overall dough recipe. The dough was sheeted, fed to a rotary molder having a die, the extrudate was cut into dog snack biscuits in shapes similar to commercial MilkBone® products, which then were frozen without being previously dried. The moisture content of the frozen control biscuits was in excess of 14% by weight.

Testing was performed in the above-mentioned three-foot diameter WINDHEXE apparatus with compressed air introduced at 285° F. (inlet), 1,000 cfm and 52 psig. About 200 pounds of the frozen pet food biscuits were introduced into the cyclone described in Example 1. The process converted the frozen pet food biscuits into a dry and powdery material having an average particle size of about 2 to about 50 microns, and a moisture content of about 2%. Granulated product was discharged from the bottom of the cyclone in about two seconds after the frozen pet food biscuits had been introduced into the processing unit.

A fresh batch of pet food biscuits were prepared containing the ground pet food biscuits as “meal rework” recovered from the above-described vortex processing, as re-work in additional pet food biscuit production. A pet food dough was formulated and prepared into pet food biscuits in a manner similar that described above with the modification that the pet food dough formulation contained about 7% meal rework. The dough formulation containing the meal rework generally contained, on a dry basis, 80% flour, 7% meal rework, 7% meat and bone meal, 2% tallow, 1% salt, 0.6% dicalcium phosphate, 0.9% natural flavorants, 0.14% vitamin premix, 0.14% calcium carbonate, and 0.4% dough conditioners. About 20-30% water (added) was used in the dough preparation, based on the overall dough recipe. The dough was formed into individual shaped biscuits in a manner similar to that described above, which were then baked in an oven and dried in a conventional manner such as generally described in U.S. Pat. No. 5,000,943, to a moisture content of less than 15%. The pet food biscuits were packaged in an air-tight manner until served.

The dried pet food biscuits made with meal rework obtained were evaluated for palatability with dogs used as test animals. A control batch of the pet food biscuits were prepared using the above-indicated control dough formulation and manufactured in a similar manner as the inventive pet food biscuits except without including the meal rework component. The amounts of the remaining ingredients were increased proportionally. The average caloric content value (calories/ounce) of each type of pet food was determined by using the conventionally-known “4-9-4” rule” for estimating calories in foods.

The pet food biscuits made with meal rework and the control pet food (without the rework) were evaluated in a kennel study comprising a 40 dog palatability test. The test dogs were 40 “large” sized dogs (i.e., dogs having a weight exceeding approximately 45 lbs.; gender: 18 male, 22 female). A split plate test was performed in which equal amounts of the control and inventive pet food were served side-by-side and separated by a divider in feed tray offered to each animal, once a day for three consecutive days. The dogs were offered a ration of each type of tested biscuit of 24-27 calories/lb/day based on animal body weight in pounds. The animals received a 50% ration of each type of biscuit on day 1, and 100% rations on days two and three. The biscuit sample placement sides on the serving plate were switched each successive test day. The animals were offered the biscuit samples for a time period of 15 minutes one hour after receiving their regular daily base meal. The animals were observed after being served and the choice of pet food biscuit, which was first approached by each animal was recorded, and also if no first approach selection was detected during the observation period. Also, the amount of each type of pet food remaining after each meal was measured for each animal, and the number of calories consumed per meal was calculated and recorded for each type of pet food tested.

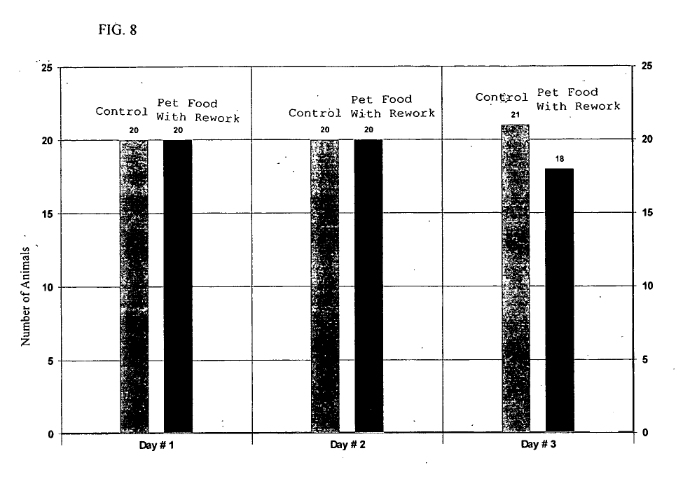

FIG. 8 is a bar graph showing the first approach selections of test animals of pet food biscuits including cereal-based dough rework obtained according to an embodiment of this invention as compared to the results for a control pet food on a day-by-day basis. As shown in FIG. 8, there was no statistically significant difference in how the test animals behaved towards the pet food biscuits containing rework as compared to the control biscuits in terms of their initial approach selections for feeding.

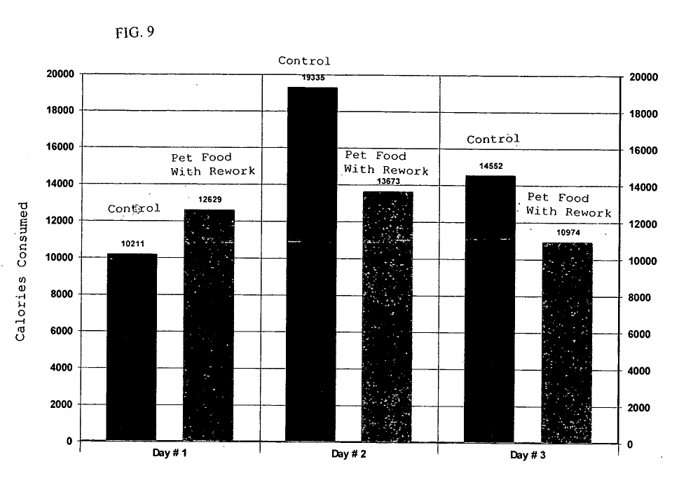

As shown in FIG. 9, there also was no statistically significant difference in the calories consumed by the test animals as between the pet food biscuits containing rework as compared to the control biscuits on each day (and an overall).

### Example 5

The granulation and use of tankage as rework in cereal-dough based pet food was evaluated. Tankage (moisture content: 60-70%) was obtained from a commercial packing plant as swine skin residual product obtained after gelatin extraction had been performed on the skin in a conventional manner.

Testing was performed in a four-foot diameter WINDHEXE apparatus with compressed air introduced at 400° F. (inlet), 1,600 cfm and 25 psig. About 2,000 pounds of the moist tankage was introduced into a cyclone structure similar to that described in Example 1, albeit at a different scale in size. The process converted the tankage into a dry and powdery material having an average particle size of about 2 to about 50 microns, and a moisture content of about 3-4%. Granulated product was discharged from the bottom of the cyclone in about two seconds after the tankage had been introduced into the processing unit.

Batches of cereal-based pet food biscuits were prepared, in which a control contained no rework comprised of the granulated tankage while a separate batch contained 2% rework comprised of the granulated tankage obtained as described above. The pet food formulation containing the tankage rework generally contained 78% flour, 2.0% meal rework, 2% poultry meal, 4% meat and bone meal, 1% salt, 10% water (added), and about 3% flavorants and vitamins. The formulation was formed into a dough material, which was then shaped, baked and dried in a general manner similar to that indicated in Example 4 to provide dog snack biscuits in shapes similar to commercial MilkBone® products, and which had a moisture content less than 15%. A control batch of pet food biscuits were prepared in a similar manner except without the meal rework. The amounts of the remaining ingredients were increased proportionally. The average caloric content value (calories/ounce) of each type of pet food biscuit sample was determined using the conventionally-known “4-9-4” rule” for estimating calories in foods.

The pet food biscuits made with meal rework and the control pet food biscuits were evaluated in a kennel study. A 40 dog palatability test was performed. The pool of test dogs included 20 “small” sized dogs (i.e., weight of approximately 10 lbs. to 20 lbs.; 11 male, 9 female) and 20 “medium” sized dogs (i.e., weight of approximately 20 lbs. to 45 lbs.; 8 male, 12 female). A split plate test was performed in which equal amounts of the control and inventive pet food biscuits were served side-by-side and separated by a divider in feed tray offered to each animal, once a day for three consecutive days. The small dogs were offered a ration of each type of tested pet food of 35-42 calories/lb/day based on their body weight in pounds, and the medium size dogs received 28-35 calories/lb/day. The pet food sample placement sides on the serving plate were switched each successive test day. The animals were offered the pet food biscuit samples for a time period of 15 minutes one hour after receiving their regular daily base meal. The amount of each type of pet food remaining after each meal was measured for each animal, and the number of calories consumed per meal was calculated and recorded for each type of pet food tested.

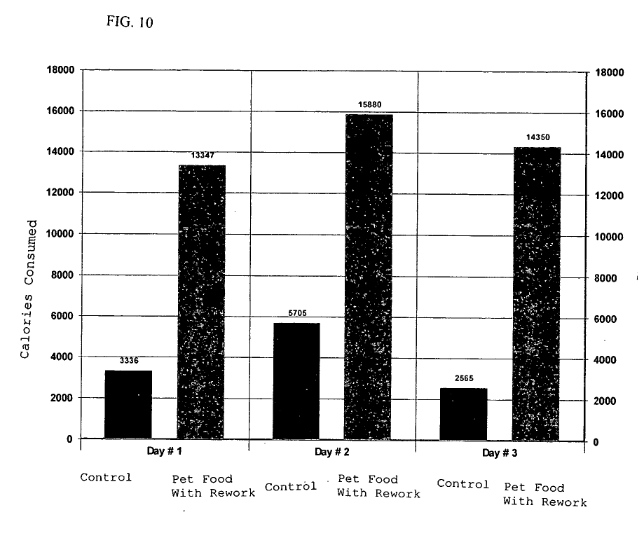

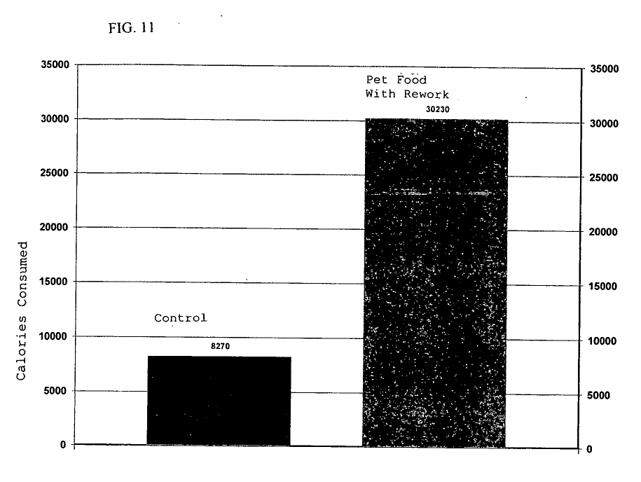

As shown in FIGS. 10-11, a preference on each day and an overall preference of approximately 3:1 was observed for the tested pet food biscuit product containing the rework formed from tankage as compared to the control product.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A granulation process for wet processed food, comprising:
introducing compressed heated air into an enclosure that includes a truncated conical shaped section, wherein the heated air travels along a downward path through the enclosure, including the conical section, to a lower end thereof, and the heated air reaching the lower end flows back up and exits the enclosure via an exhaust outlet;
introducing into the enclosure wet processed food which is entrained in the heated air traveling downward through the enclosure, wherein at least a portion of the wet processed food is dried and ground before reaching the lower end of the enclosure;
discharging a granular product including dried and ground food product from the lower end of the enclosure, wherein the dried and ground food product incurs sufficiently limited molecular structural degradation during the process such that the product is functionally and organoleptically acceptable to be used as rework.

2. The process of claim 1, wherein the wet processed food contains at least about 14 wt. % as introduced into the enclosure.

3. The process of claim 1, wherein the wet processed food contains about 14 wt. % to about 75 wt. % moisture as introduced into the enclosure; and the dried and ground food product contains about 3 wt. % to about 13 wt. % moisture.

4. The process of claim 1, wherein the granular product has an average particle size of about 1 micron to about 1,000 microns.

5. The process of claim 1, wherein the wet processed food comprises a grain-based ingredient.

6. The process of claim 5, wherein the wet processed food comprises, on a dry basis, about 1 to about 99 wt. % grain-based ingredient.

7. The process of claim 5, wherein the wet processed food comprises farinaceous material.

8. The process of claim 1, wherein the wet processed food comprises wet dough.

9. The process of claim 8, wherein the wet dough is selected from the group consisting of bread dough, pizza dough, cereal dough, pet food dough, cracker dough, baked good dough, and a mixture thereof.

10. The process of claim 8, wherein the wet dough comprises wet sheetable dough.

11. The process of claim 8, wherein the wet dough comprises at least a portion or portions of an extruded rope comprising wet cereal dough.

12. The process of claim 8, wherein the wet dough comprises wet pet food.

13. The process of claim 1, wherein the wet processed food comprises sheetable dough comprising at least about 14 wt. % liquid water.

14. The process of claim 1, wherein the wet food comprises a gelatin-extracted ruminant hide.

15. The process of claim 1, wherein the introducing of the heated air comprises supplying compressed heated air at a pressure within the range of from about 10 psig to about 100 psig.

16. The process of claim 1, wherein the introducing of the heated air comprises supplying compressed heated air at a pressure within the range of from about 15 psig to about 60 psig.

17. The process of claim 1, wherein the introducing of the heated air comprises supplying the heated air at a temperature within the range of about 120° F. to about 500° F.

18. The process of claim 1, wherein the introducing of the heated air comprises supplying the heated air at a rate of within the range of from about 500 cubic feet per minute to about 10,000 cubic feet per minute.

19. A process for reworking wet processed food in processed food manufacture, comprising:
introducing compressed heated air into an enclosure that includes a truncated conical shaped section, wherein the heated air travels along a downward path through the enclosure, including the conical section, to a lower end thereof, and the heated air reaching the lower end flows back up and exits the enclosure via an exhaust outlet;
introducing into the enclosure wet processed food which is entrained in the heated air traveling downward through the enclosure, wherein at least a portion of the wet processed food is dried and ground before reaching the lower end of the enclosure;
discharging a granular product including dried and ground food product from the lower end of the enclosure, wherein the dried and ground food product incurs sufficiently limited molecular structural degradation during the process conducted in the enclosure such that the product is functionally and organoleptically acceptable to be used as rework;
combining at least a portion of the granular product and at least one different processed food ingredient; and
preparing a processed food product therewith.

20. A granular food product prepared from wet processed food in a method comprising introducing compressed heated air into an enclosure that includes a truncated conical shaped section, wherein the heated air travels along a downward path through the enclosure, including the conical section, to a lower end thereof, and the heated air reaching the lower end flows back up and exits the enclosure via an exhaust outlet; introducing into the enclosure wet processed food which is entrained in the heated air traveling downward through the enclosure, wherein at least a portion of the wet processed food is dried and ground before reaching the lower end of the enclosure; and discharging from the lower end of the enclosure a granulated product including dried and ground food product, wherein the dried and ground food product incurs sufficiently limited molecular structural degradation during the process such that the product is functionally and organoleptically acceptable to be used as rework.

21. The granular food product of claim 20, wherein the wet processed food comprises a grain-based ingredient.

22. The granular food product of claim 21, wherein the wet processed food comprises farinaceous material.

23. The granular food product of claim 21, wherein the wet processed food comprises wet dough.
